(19) United States
(12) Patent Application Publication
(10) Pub. No.: US 2026/0074098 A1
(43) Pub. Date: Mar. 12, 2026

(54) VARISTOR INCLUDING REFLOWABLE THERMAL PROTECTION DEVICE ON VARISTOR SURFACE

(71) Applicant: Littelfuse, Inc., Rosemont, IL (US)

(72) Inventors: Jianhua Chen, Sunnyvale, CA (US); Marco Doms, Berlin (DE); Chun-Kwan Tsang, Newark, CA (US)

(73) Assignee: Littelfuse, Inc., Rosemont, IL (US)

(21) Appl. No.: 19/307,143

(22) Filed: Aug. 22, 2025

Related U.S. Application Data
(60) Provisional application No. 63/691,573, filed on Sep. 6, 2024.

(51) Int. Cl. H01C 7/12; H01H 85/04

(52) U.S. Cl. CPC H01C 7/12; H01H 85/04

(57) ABSTRACT

A circuit protection device may include a varistor body including a first side, wherein a thermal electrode is disposed along the first side, and wherein a first lead is electrically connected to the thermal electrode and a second lead is electrically connected to a second side. The circuit protection device may further include a reflowable circuit protection device atop the thermal electrode, and a third lead connected to the reflowable circuit protection device, wherein an end of the third lead is a spring connected to the thermal electrode by a conductive element.

### CROSS-REFERENCE TO RELATED APPLICATION

This application claims priority to pending U.S. Provisional Patent Application No. 63/691,573, filed September 6, 2024, which is incorporated by reference herein in its entirety.

### FIELD OF THE DISCLOSURE

The disclosure relates generally to the protection of electrical and electronic circuits and equipment from power surges and, more particularly, to a thermally-protected varistor having a reflowable surface mount circuit protection device.

### BACKGROUND OF THE DISCLOSURE

Over-voltage protection devices are used to protect electronic circuits and components from damage due to over-voltage fault conditions. These over-voltage protection devices may include metal oxide varistors (MOVs) that are connected between the circuits to be protected, and a ground line. MOVs have a specific current-voltage characteristic that allows them to be used to protect such circuits against catastrophic voltage surges. Typically, these devices utilize spring elements and a linking element, which can melt during an abnormal condition to form an open circuit. In particular, when a voltage that is larger than the nominal or threshold voltage is applied to the device, current flows through an MOV, which generates heat. This causes the linking element to melt. Once the linking element melts, an open circuit is created once the spring moves, which prevents the MOV from catching fire.

Although thermally protected varistors are presently available, the currently available thermal disconnect varistors sometimes have lower reliability, particularly for automotive applications (e.g., AEC-Q standards). It is with respect to these and other considerations that the present improvements are provided.

### SUMMARY OF THE DISCLOSURE

A circuit protection device may include a varistor body including a first side, wherein a thermal electrode is disposed along the first side, and wherein a first lead is electrically connected to the thermal electrode and a second lead is electrically connected to a second side. The circuit protection device may further include a reflowable circuit protection device atop the thermal electrode, and a third lead connected to the reflowable circuit protection device, wherein an end of the third lead is a spring connected to the thermal electrode by a conductive element.

A fuse may include a varistor body having a first side opposite a second side, and a thermal electrode disposed along the first side, wherein a first lead is electrically connected to the thermal electrode and a second lead is electrically connected to the second side. The fuse may further include a reflowable circuit protection device connected to the thermal electrode, and a third lead connected to the reflowable circuit protection device, wherein an end of the third lead is a spring connected to the thermal electrode by a conductive element.

A method of operating a circuit protection device may include electrically connecting a first lead to a thermal electrode along a first side of a varistor body, and electrically connecting a second lead to a second side of the varistor body. The method may further include connecting a reflowable circuit protection device to the thermal electrode, and connecting a third lead to the reflowable circuit protection device, wherein an end of the third lead is a spring connected to the thermal electrode by a conductive element. The method may further include receiving a force to a restraining element of the reflowable circuit protection device to cause the end of the third lead to move away from the thermal electrode in response to a thermal event.

### BRIEF DESCRIPTION OF THE DRAWINGS

The accompanying drawings illustrate exemplary approaches of the disclosed embodiments so far devised for the practical application of the principles thereof, and in which:

FIG. 1 is a top view of a circuit protection device including a reflowable circuit protection device according to embodiments of the present disclosure;

FIGS. 2A - 2B are top views of a circuit protection device including a reflowable circuit protection device according to embodiments of the present disclosure;

FIGS. 3A - 3C demonstrate operation of a reflowable circuit protection device according to embodiments of the present disclosure;

FIGS. 4A - 4C demonstrate operation of a circuit protection device including a reflowable circuit protection device according to embodiments of the present disclosure;

FIGS. 5A - 5C demonstrate operation of a circuit protection device including a reflowable circuit protection device according to embodiments of the present disclosure;

FIGS. 6A - 6C demonstrate operation of a circuit protection device including a reflowable circuit protection device according to embodiments of the present disclosure;

FIGS. 7A - 7D demonstrate operation of a reflowable circuit protection device according to embodiments of the present disclosure;

FIGS. 8A - 8D demonstrate operation of a circuit protection device including a reflowable circuit protection device according to embodiments of the present disclosure; and

FIG. 9 demonstrates one non-limiting chart demonstrating solder link resistance vs. reflow number and temperature.

The drawings are not necessarily to scale. The drawings are merely representations, not intended to portray specific parameters of the disclosure. The drawings are intended to depict typical embodiments of the disclosure, and therefore should not be considered as limiting in scope. In the drawings, like numbering represents like elements.

Furthermore, certain elements in some of the figures may be omitted, or illustrated not-to-scale, for illustrative clarity. Furthermore, for clarity, some reference numbers may be omitted in certain drawings.

### DETAILED DESCRIPTION

Embodiments in accordance with the present disclosure will now be described more fully hereinafter with reference to the accompanying drawings. The system/circuit may be embodied in many different forms and should not be construed as being limited to the embodiments set forth herein. Rather, these embodiments are provided so that this disclosure will be thorough and complete, and will fully convey the scope of the system and method to those skilled in the art.

As will be apparent herein, the circuit protection devices of the present disclosure can address the problems of the prior art, namely high cost and low reliability, by forming a highly reliable open circuit using a fuse coupled with a reflowable circuit protection device. During an overheating event caused by an abnormal overvoltage condition, the circuit protection device can protect the circuit from damage.

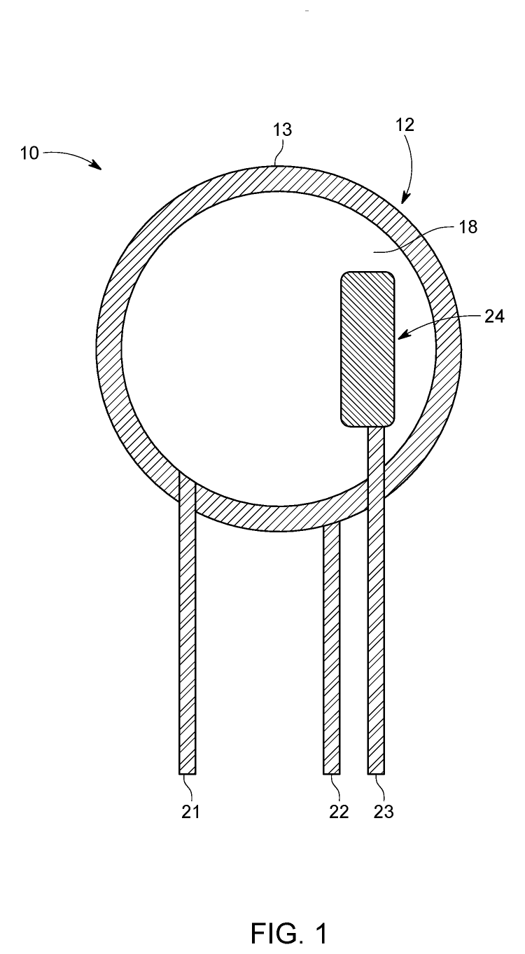

Turning now to FIG. 1, a circuit protection assembly/device 10 for use with an electrical circuit according to embodiments of the disclosure will be described. As shown, the device 10 includes a varistor body 12, which in this embodiment has a circular or cylindrical shape defined generally by an outer perimeter 13. The varistor body 12 includes a first side opposite a second side, and a thermal electrode 18 disposed along the first side. A first lead 21 is electrically connected to the thermal electrode 18, a second lead 22 is electrically connected to the second side, and a third lead 23 is electrically connected to a reflowable circuit protection device (RTP) 24 and to the thermal electrode 18. In some embodiments, the thermal electrode 18 is a metallization layer of ceramic, silver, copper, aluminum, or copper plus aluminum. The first lead 21, the second lead 22, and/or the third lead 23 may be secured to respective first and second sides of the varistor 12 using a high-temperature solder. Although not shown, the device 10 may be encased/surrounded by a conformal epoxy or other high isolation material. In the case the RTP 24 includes the low temperature thermal sensing element, the RTP 24 will be a reflowable circuit protection device. In the case no thermal sensing element is present, the RTP 24 will be a reflowable thermal protection device.

In some embodiments, the RTP 24 may be soldered on the surface of the thermal electrode 18 and connected to the terminals, or the RTP can be mounted on the outer perimeter 13. The RTP 124 may be a high-current reflowable thermal protection device, which is a low-resistance, surface mountable thermal protector. The RTP may have a set open temperature, and can be installed using a lead-free, surface mount device (SMD) assembly and reflow process.

In general, the RTP 24 includes a conduction element through which a load current flows, and an elastic element adapted to apply a force on the conduction element. In some embodiments, the conduction element incorporates a sensing element. When the temperature of the sensing element exceeds a threshold, the sensing element becomes susceptible to deformation and/or breakage via the force on the conduction element applied by the elastic element. Eventually, the conduction element mechanically opens under the force, resulting in an open circuit condition. In other embodiments, the sensing element and the conduction element are separate, and the sensing element acts to keep the conduction element in a low resistance state.

During a reflow process, the sensing element may lose its resilience. To prevent the force applied by the elastic element from opening the conduction element during installation, a restraining element may be utilized to maintain the elastic element in a state whereby the elastic element does not apply force on the conduction element. After the reflowable thermal fuse is installed on a panel and passed through a reflow oven, the restraining element may be blown by applying an activating current through the restraining element. This in turn activates the reflowable thermal fuse. The details of the RTP 24 are set out in more detail below. The accompanying drawings are included to provide a further understanding and are incorporated in and constitute a part of this specification.

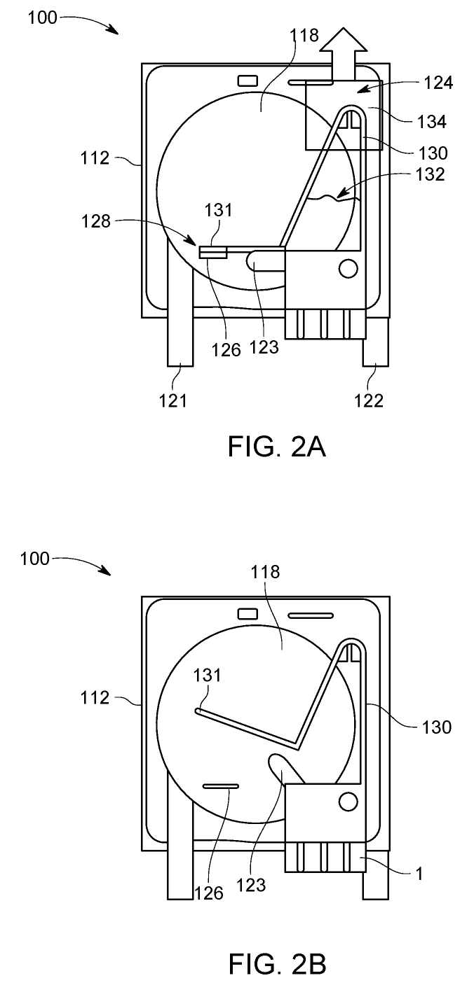

FIGS. 2A - 2B demonstrates an example device 100 in greater detail. The device 100 includes a varistor body 112 including a thermal electrode 118. A first lead 121 is electrically connected to the thermal electrode 118, a second lead 122 is electrically connected to the second side, and a third lead 123 is electrically connected to a RTP 124. In some embodiments, a conductive element 126 (e.g., solder and/or an inner electrode) may be disposed along the thermal electrode 118, wherein the third lead 123 forms an electrical connection 128 with the conductive element 126. An end 131 of the third lead 123 may be an elastic element 130 (e.g., spring), which is connected to the thermal electrode 118 by the conductive element 126. The elastic element 130 may be made of a conductive material, such as copper or stainless steel, or a non-conductive material, such as plastic or fiber reinforced plastic composite. Other materials and structures may be utilized. The elastic element 130 may receive a current flow, and may be adapted to apply a force on the conductive element 126. When the temperature of the conductive element 126 exceeds a threshold, it becomes susceptible to deformation and/or breakage via the force from the elastic element 130. Eventually, the conductive element 126 mechanically opens under the force, resulting in an open circuit condition, as demonstrated in FIG. 2B.

During a reflow process, to prevent the force applied by the elastic element 130 from opening the conductive element 126 during installation, one or more restraining elements 132, 134 may be utilized as part of the RTP 124 to maintain the elastic element 130 in a state whereby the elastic element 130 does not apply force on the conductive element 126. After the reflowable thermal fuse is installed on the varistor body 112, the restraining element(s) 132, 134 may be blown by applying an activating current and/or mechanical force through the restraining element(s) 132, 143. This in turn activates the reflowable thermal fuse.

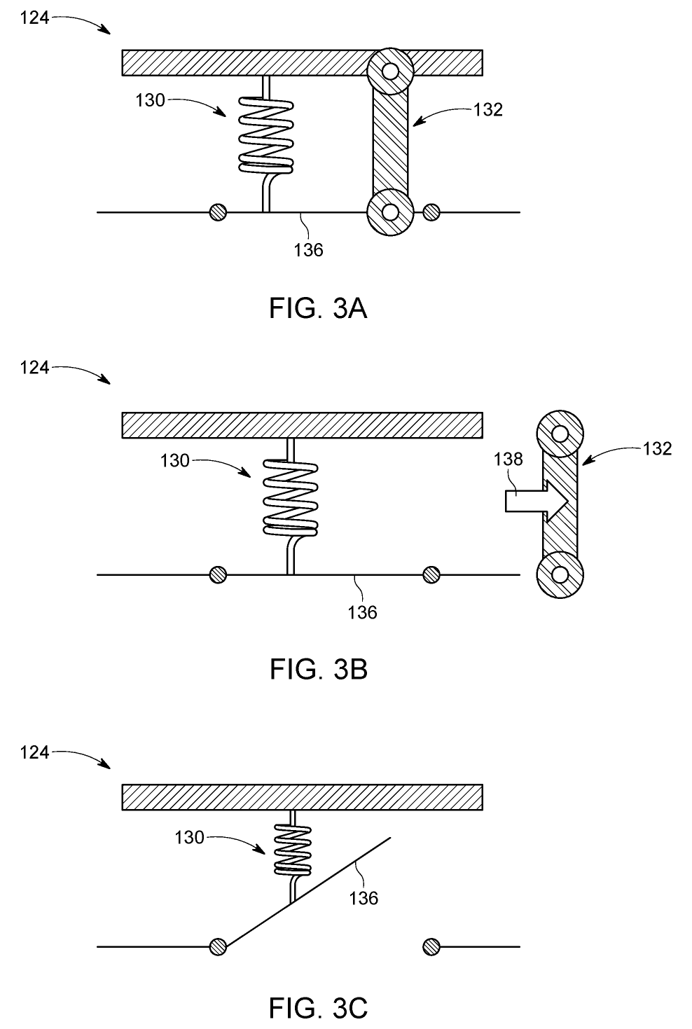

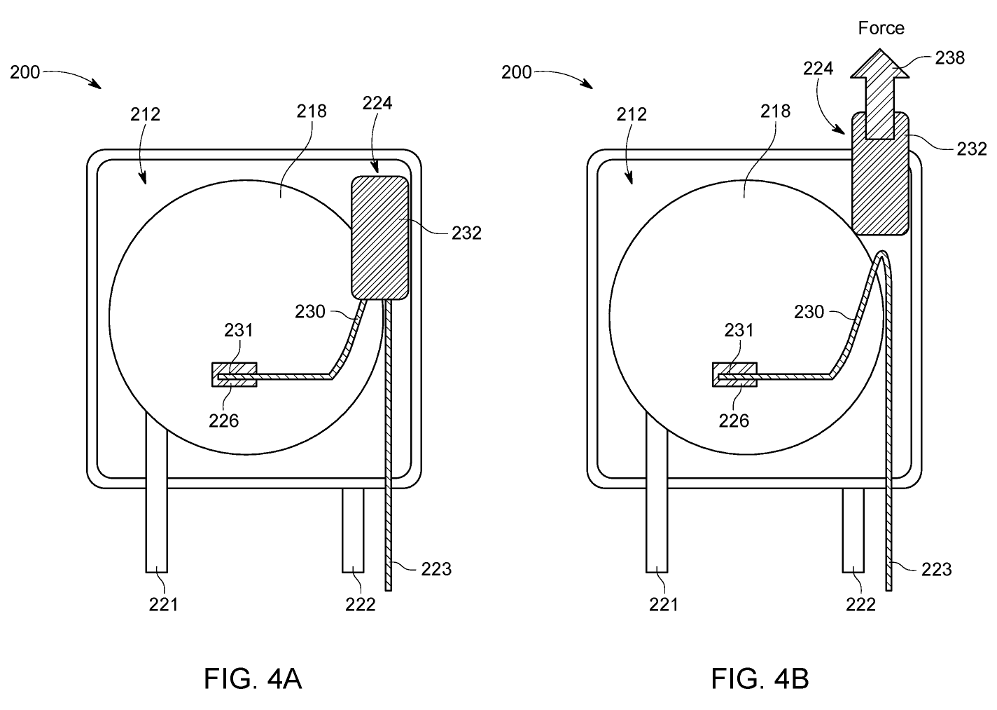

FIGS. 3A - 3C illustrate various states of an embodiment of the RTP 124. In FIG. 3A, the RTP 124 is in an initial/reflow state. In this state, the restraining element 132 is utilized to prevent the elastic element 130 from applying a force on conductive element 136.

FIG. 3B illustrates the RTP 124 in an activated/armed state. In the embodiment shown, an electrical or mechanical force 138 may be provided to the restraining element 132 to move the restraining element 132 away from the conductive element 136 and/or the elastic element 130. Once the opening is formed the elastic element 130 may be released so that it may apply force on the conductive element 136.

FIG. 3C illustrates the RTP 124 during a fault/active protection condition. In this state, a force applied via the elastic element 130 causes an opening to form in the conductive element 136.

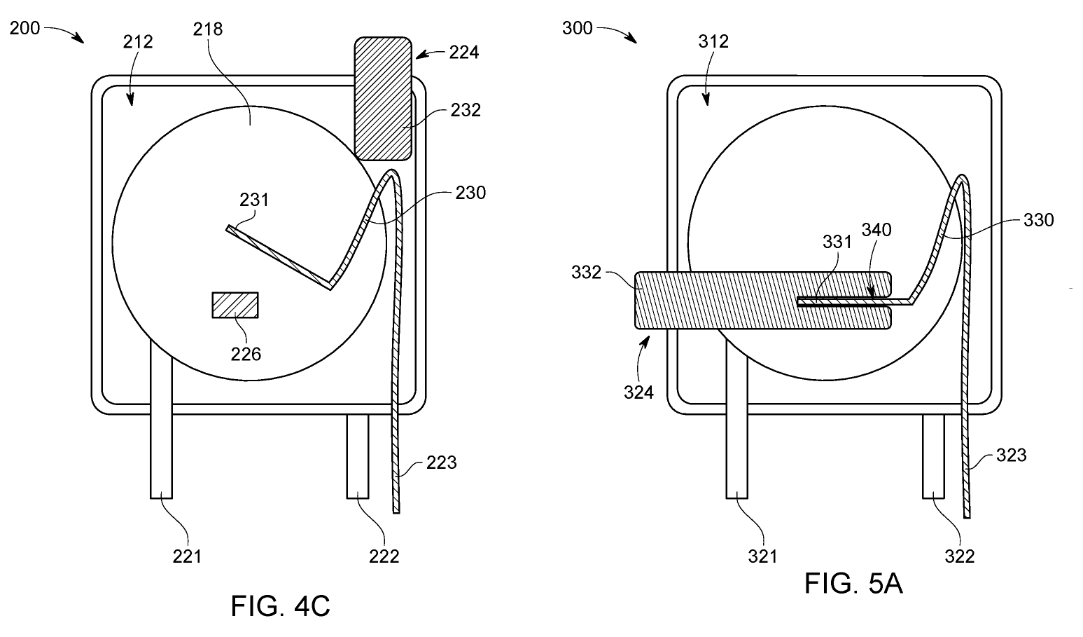

FIGS. 4A - 4C illustrate various states of an embodiment of a device 200. The device 200 may be the same or similar to the device 10 described herein. As such, only certain aspects of the device 200 will hereinafter be described for the sake of brevity. The device 200 includes a varistor body 212 including a thermal electrode 218. A first lead 221 is electrically connected to the thermal electrode 218, a second lead 222 is electrically connected to the second side, and a third lead 223 is electrically connected to a RTP 224. As shown, a conductive element 226 (e.g., solder and/or an inner electrode) may be disposed along the thermal electrode 218, wherein an end 231 of the third lead 223 forms an electrical connection with the conductive element 226. The third lead 223 may be include an elastic element 230 (e.g., spring), which is connected to the thermal electrode 218 by the conductive element 226. The elastic element 230 may receive a current flow, and may be adapted to apply a force on the conductive element 226.

In FIG. 4A, the RTP 224 is in an initial/reflow state. In this state, a restraining element 232 is utilized to prevent the elastic element 230 from applying a force on conductive element 226.

FIG. 4B illustrates the RTP 224 in an activated/armed state. In the embodiment shown, an electrical or mechanical force 238 may be provided to the restraining element 232 to move the restraining element 232 away from the elastic element 230. Once the opening is formed, the elastic element 230 may be released so that it may apply force on the conductive element 226.

FIG. 4C illustrates the RTP 224 during a fault/active protection condition. In this state, a force applied via the elastic element 230 causes an opening to form between the end 231 and the conductive element 226, e.g., when the conductive element 226 exceeds a temperature threshold and begins to soften/deform.

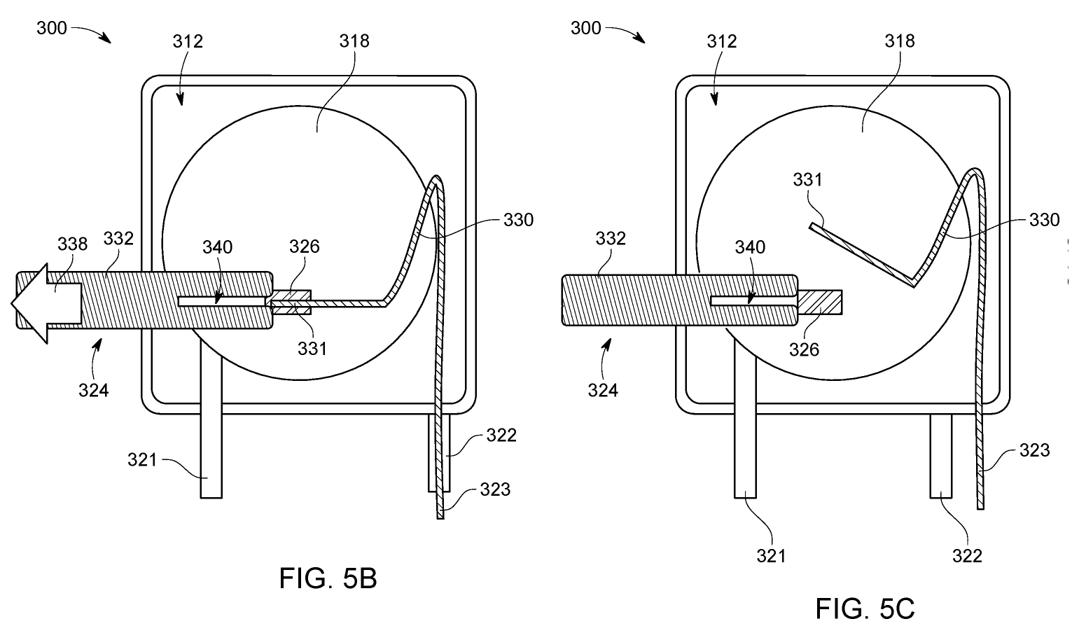

FIGS. 5A - 5C illustrate various states of an embodiment of a device 300. The device 300 may be the same or similar to the devices described herein. As such, only certain aspects of the device 300 will hereinafter be described for the sake of brevity. The device 300 includes a varistor body 312 including a thermal electrode 318. A first lead 321 is electrically connected to the thermal electrode 318, a second lead 322 is electrically connected to the second side, and a third lead 323 is electrically connected to a RTP 324. A conductive element 326 (e.g., solder and/or an inner electrode) may be disposed along the thermal electrode 318, wherein an end 331 of the third lead 323 forms an electrical connection with the conductive element 326. The third lead 323 may be include an elastic element 330 (e.g., spring), which is connected to the thermal electrode 318 by the conductive element 326. The elastic element 330 may receive a current flow, and may be adapted to apply a force on the conductive element 326.

In FIG. 5A, the RTP 324 is in an initial/reflow state. In this state, a restraining element 332 is utilized to prevent the elastic element 330 from applying a force on conductive element 326. More specifically, the end 331 of the elastic element 330 may be held within a slot 340 of the restraining element 332. As shown, the restraining element 332 may be positioned directly over the conductive element 326.

FIG. 5B illustrates the RTP 324 in an activated/armed state. In the embodiment shown, an electrical or mechanical force 338 may be provided to the restraining element 332 to move the restraining element 332 away from the elastic element 330. Once the opening is formed, the elastic element 330 may be released so that it may apply force on the conductive element 326.

FIG. 5C illustrates the RTP 324 during a fault/active protection condition. In this state, a force applied via the elastic element 330 causes an opening to form between the end 331 and the conductive element 326, e.g., when the conductive element 326 exceeds a temperature threshold and begins to soften/deform.

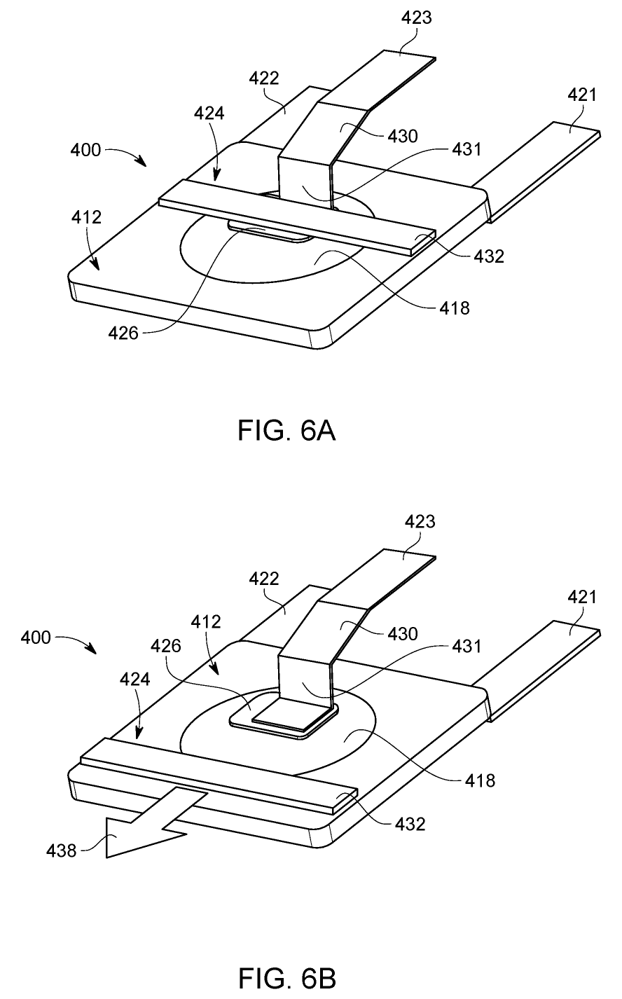

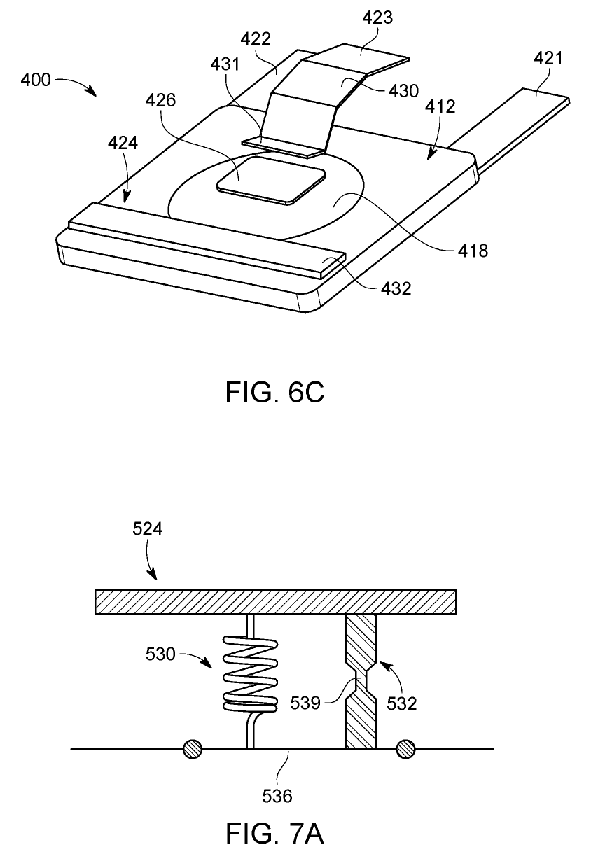

FIGS. 6A - 6C illustrate various states of an embodiment of a device 400. The device 400 includes a varistor body 412 including a thermal electrode 418. A first lead 421 is electrically connected to the thermal electrode 418, a second lead 422 is electrically connected to the second side, and a third lead 423 is electrically connected to a RTP 424. A conductive element 426 (e.g., solder and/or an inner electrode) may be disposed along the thermal electrode 418, wherein an end 431 of the third lead 423 forms an electrical connection with the conductive element 426. The third lead 423 may be include an elastic element 430 (e.g., spring), which is connected to the thermal electrode 418 by the conductive element 426. The elastic element 430 may receive a current flow, and may be adapted to apply a force on the conductive element 426.

In FIG. 6A, the RTP 424 is in an initial/reflow state. In this state, a restraining element 432 is utilized to prevent the elastic element 430 from applying a force on conductive element 426. More specifically, the end 431 of the elastic element 430 may be held beneath the restraining element 432.

FIG. 6B illustrates the RTP 424 in an activated/armed state. In the embodiment shown, an electrical or mechanical force 438 may be provided to the restraining element 432 to move the restraining element 432 away from the elastic element 430. Once the opening is formed, the elastic element 430 may be released so that it may apply force on the conductive element 426.

FIG. 6C illustrates the RTP 424 during a fault/active protection condition. In this state, a force applied via the elastic element 430 causes an opening to form between the end 431 and the conductive element 426, e.g., when the conductive element 426 exceeds a temperature threshold and begins to soften/deform.

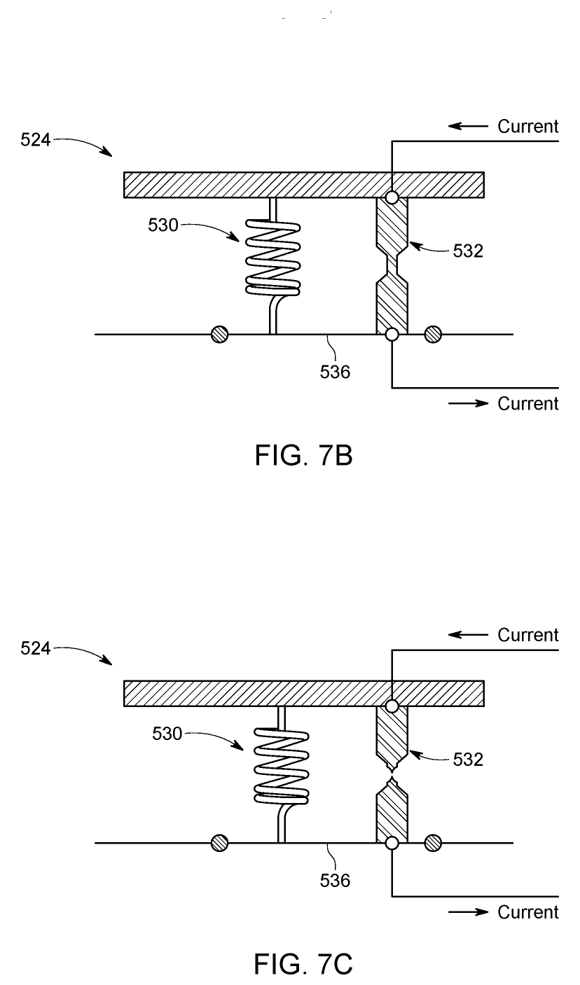

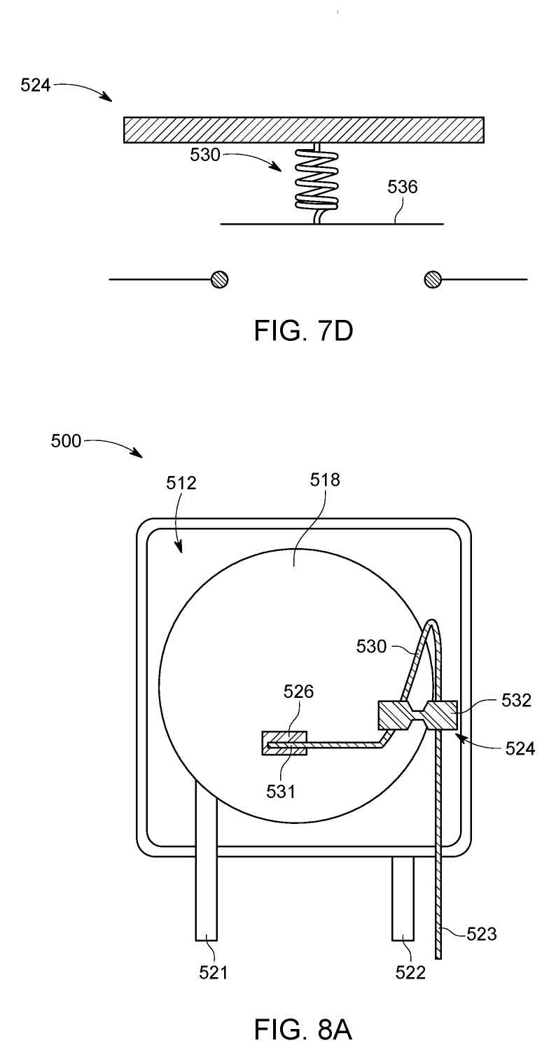

FIGS. 7A - 7D illustrate various states of an embodiment of an RTP 524. In this embodiment, the RTP 524 may include a restraining element 532 in the form of a fusible link, which may be made from a material with a higher melting temperature than reflow temperature. As shown, the fusible link may have a weakened center section 539. The restraining element 532 may be made of copper, stainless steel, or an alloy. Other materials and structures may be utilized.

In FIG. 7A, the RTP 524 is in an initial/reflow state. In this state, the restraining element 532 is utilized to prevent an elastic element 530 from applying a force on conductive element 536.

FIG. 7B illustrates the RTP 524 in an activated/armed state. In the embodiment shown, a current may be provided to the restraining element 532, which causes the restraining element 532 to break/open, e.g., in the weakened center section 539 thereof, as shown in FIG. 7C. Once the opening is formed the elastic element 530 may be released so that it may apply force on the conductive element 536.

FIG. 7D illustrates the RTP 524 during a fault/active protection condition. In this state, a force applied via the elastic element 530 causes an opening to form in the conductive element 536.

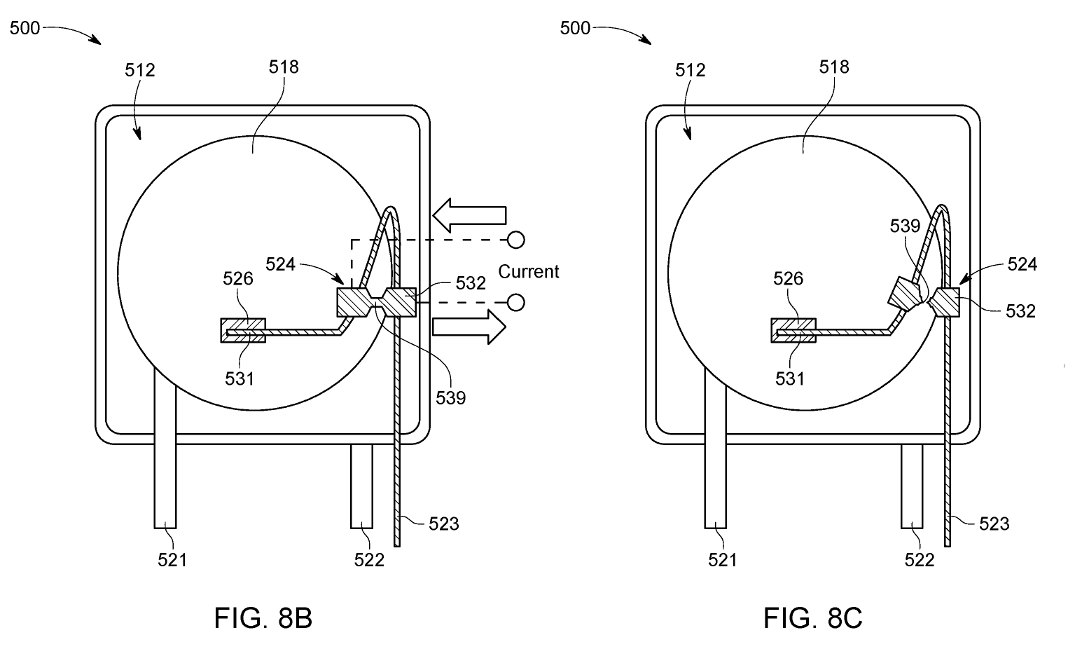

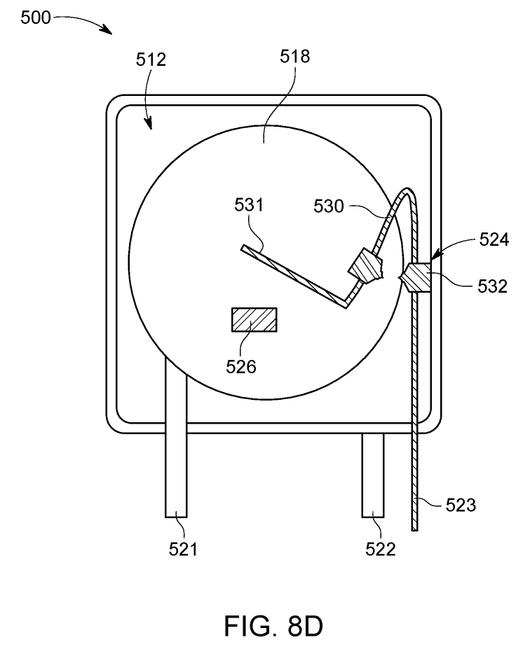

FIGS. 8A - 8D illustrate various states of an embodiment of a device 500. The device 500 includes a varistor body 512 including a thermal electrode 518. A first lead 521 is electrically connected to the thermal electrode 518, a second lead 522 is electrically connected to the second side, and a third lead 523 is electrically connected to the RTP 524. A conductive element 526 (e.g., solder and/or an inner electrode) may be disposed along the thermal electrode 518, wherein an end 531 of the third lead 523 forms an electrical connection with the conductive element 526. The third lead 523 may be include an elastic element 530 (e.g., spring), which is connected to the thermal electrode 518 by the conductive element 526. The elastic element 530 may receive a current flow, and may be adapted to apply a force on the conductive element 526.

In FIG. 8A, the RTP 524 is in an initial/reflow state. In this state, the restraining element 532 is utilized to prevent the elastic element 530 from applying a force on conductive element 526.

FIG. 8B illustrates the RTP 524 in an activated/armed state. In the embodiment shown, a current may be provided to the restraining element 532, which causes the restraining element 532 to break/open, e.g., in the weakened center section 539 thereof, as shown in FIG. 8C. Once the opening is formed the elastic element 530 may be released so that it may apply force on the conductive element 536.

FIG. 8D illustrates the RTP 524 during a fault/active protection condition. In this state, a force applied via the elastic element 430 causes an opening to form between the end 431 and the conductive element 426, e.g., when the conductive element 426 exceeds a temperature threshold and begins to soften/deform.

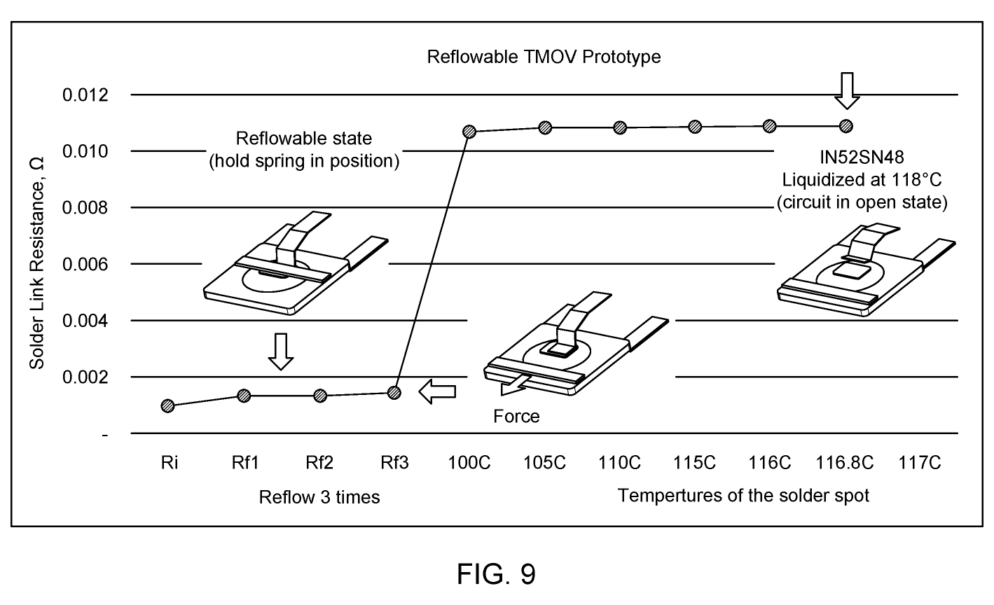

FIG. 9 demonstrates one non-limiting chart demonstrating solder link resistance vs. reflow number and temperature.

For the sake of convenience and clarity, terms such as “top,” “bottom,” “upper,” “lower,” “vertical,” “horizontal,” “lateral,” and “longitudinal” will be used herein to describe the relative placement and orientation of various components and their constituent parts. Said terminology will include the words specifically mentioned, derivatives thereof, and words of similar import.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

Furthermore, in the following description and/or claims, the terms “on,” “overlying,” “disposed on” and “over” may be used in the following description and claims. “On,” “overlying,” “disposed on” and “over” may be used to indicate that two or more elements are in direct physical contact with each other. However, “on,”, “overlying,” “disposed on,” and over, may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

While the present disclosure has been described with reference to certain approaches, numerous modifications, alterations and changes to the described approaches are possible without departing from the sphere and scope of the present disclosure, as defined in the appended claims. Accordingly, it is intended that the present disclosure not be limited to the described approaches, but that it has the full scope defined by the language of the following claims, and equivalents thereof. While the disclosure has been described with reference to certain approaches, numerous modifications, alterations and changes to the described approaches are possible without departing from the spirit and scope of the disclosure, as defined in the appended claims. Accordingly, it is intended that the present disclosure not be limited to the described approaches, but that it has the full scope defined by the language of the following claims, and equivalents thereof.

What is claimed is:

1. A circuit protection device, comprising:
a varistor body, comprising:
a first side; and
a thermal electrode disposed along the first side, wherein a first lead is electrically connected to the thermal electrode and a second lead is electrically connected to a second side;
a reflowable circuit protection device atop the thermal electrode; and
a third lead connected to the reflowable circuit protection device, wherein an end of the third lead is a spring connected to the thermal electrode by a conductive element.

2. The circuit protection device of claim 1, wherein the reflowable circuit protection device comprises one or more restraining elements and one or more elastic elements.

3. The circuit protection device of claim 2, wherein the spring of the third lead is coupled to the one or more restraining elements.

4. The circuit protection device of claim 3, wherein in a first configuration the one or more restraining elements retains the spring in a first position, and wherein in a second configuration the one or more restraining elements releases the spring to a second position.

5. The circuit protection device of claim 2, wherein the one or more restraining elements is a fusible element.

6. The circuit protection device of claim 5, wherein a current through the fusible element causes a weakened center portion of the fusible element to open.

7. The circuit protection device of claim 2, wherein the one or more elastic elements is a second spring.

8. A fuse, comprising:
a varistor body, comprising:
a first side opposite a second side; and
a thermal electrode disposed along the first side, wherein a first lead is electrically connected to the thermal electrode and a second lead is electrically connected to the second side;
a reflowable circuit protection device connected to the thermal electrode; and
a third lead connected to the reflowable circuit protection device, wherein an end of the third lead is a spring connected to the thermal electrode by a conductive element.

9. The fuse of claim 8, wherein the reflowable circuit protection device comprises one or more restraining elements and one or more elastic elements.

10. The fuse of claim 9, wherein the spring of the third lead is coupled to the one or more restraining elements.

11. The fuse of claim 10, wherein in a first configuration the one or more restraining elements retains the spring in a first position, and wherein in a second configuration the one or more restraining elements releases the spring to a second position.

12. The fuse of claim 9, wherein the one or more restraining elements is a fusible element.

13. The fuse of claim 12, wherein a current through the fusible element causes a weakened center portion of the fusible element to open.

14. The fuse of claim 9, wherein the one or more elastic elements is a second spring.

15. A method of operating a circuit protection device, comprising:
electrically connecting a first lead to a thermal electrode along a first side of a varistor body;
electrically connecting a second lead to a second side of the varistor body;
connecting a reflowable circuit protection device to the thermal electrode; and
connecting a third lead to the reflowable circuit protection device, wherein an end of the third lead is a spring connected to the thermal electrode by a conductive element;
receiving a force to a restraining element of the reflowable circuit protection device to cause the end of the third lead to move away from the thermal electrode in response to a thermal event.

16. The method of claim 15, wherein in a first configuration the restraining element retains the spring in a first position, and wherein in a second configuration the restraining element releases the spring to a second position.
